(19) United States
(12) Patent Application Publication
(10) Pub. No.: US 2026/0042976 A1
(43) Pub. Date: Feb. 12, 2026

(54) COMPOSITIONS AND METHODS OF USE THEREOF

(71) Applicant: Fujifilm Electronic Materials U.S.A., Inc., N. Kingstown, RI (US)

(72) Inventors: Yannan Liang, Gilbert, AZ (US); Ting-Kai Huang, Queen Creek, AZ (US); Bin Hu, Chandler, AZ (US); Hanyu Fan, Chandler, AZ (US); Hong Piao, Gilbert, AZ (US)

(21) Appl. No.: 19/292,995

(22) Filed: Aug. 7, 2025

Related U.S. Application Data
(60) Provisional application No. 63/680,789, filed on Aug. 8, 2024.

(51) Int. Cl. C11D 3/28; C11D 1/66; C11D 3/00; C11D 3/20; C11D 3/36; C11D 3/37; C11D 3/43

(52) U.S. Cl. CPC C11D 3/28; C11D 1/66; C11D 3/0047; C11D 3/2075; C11D 3/36; C11D 3/37; C11D 3/43; C11D 2111/22

(57) ABSTRACT

This disclosure relates to a composition that includes at least one surface roughness controller; at least one pH adjuster; at least one particle dispersion agent; at least one chelating agent; at least one corrosion inhibitor; and an aqueous solvent, in which the composition has a pH of from about 7 to about 14.

### CROSS-REFERENCE TO RELATED APPLICATION

The present application claims priority to U.S. Provisional Application Ser. No. 63/680,789, filed on Aug. 8, 2024, the contents of which are hereby incorporated by reference in their entirety.

### FIELD

The present disclosure relates to cleaning compositions for use with semiconductor substrates.

### BACKGROUND

The semiconductor industry is continually driven to improve chip performance by further miniaturization of devices through process and integration innovations. Chemical Mechanical Polishing/Planarization (CMP) is a powerful technology as it makes many complex integration schemes at the transistor level possible, thereby facilitating increased chip density.

CMP is a process used to planarize/flatten a wafer surface by removing material using abrasion-based physical processes concurrently with surface-based chemical reactions. In general, a CMP process involves applying CMP slurry (e.g., an aqueous chemical formulation) to a wafer surface while contacting the wafer surface with a polishing pad and moving the polishing pad in relation to the wafer. CMP slurries typically include an abrasive component and dissolved chemical components, which can vary significantly depending upon the materials present on the wafer (e.g., metals, metal oxides, metal nitrides, dielectric materials such as silicon oxide, silicon nitride, etc.) that will be interacting with the slurry and the polishing pad during the CMP process.

After CMP processing, the polished wafers are usually rinsed with deionized water, commonly referred to as high pressure rinsing, to terminate any chemical reactions and remove water miscible components (e.g., pH adjusters, organic components, and oxidants) and byproducts (e.g., ionic metals removed during CMP or pad debris) left on the polished wafer after the CMP processing step. However, even after the deionized water rinse, a variety of contaminants may remain on the surface of the polished wafer. Contaminants may include, for example, particulate abrasive from the CMP slurry, organic residue from the pad or slurry components, and material removed from the wafer during the CMP process. If left on the surface of the polished wafer, these contaminants may lead to failures during further wafer processing steps and/or to diminished device performance. Thus, the contaminants need to be effectively removed so that the polished wafer may predictably undergo further processing and/or to achieve optimal device performance.

Commonly, the process of removing these post-polishing contaminants or residues on the wafer surface after CMP (and the deionized water rinse) is performed with post-CMP (P-CMP) cleaning solutions. P-CMP cleaning solutions are applied to the polished wafer using a brush scrubber or a spin rinse dry apparatus (i.e., the wafer is removed from the CMP polishing tool and transferred to a different apparatus for P-CMP cleaning). Nonetheless, with the complex integration schemes and scaling down of size in advanced node semiconductor manufacturing, it has been increasingly noticed that traditional P-CMP cleaning is insufficient to adequately remove contaminants from the polished wafer.

### SUMMARY

In semiconductor chip manufacturing, defectivity on the wafer surface is the key to the yield of the wafers which determines the top and bottom line of chip companies globally. A typical wafer goes through about 1000 processes before chips are made and the individual dies are cut from the wafer. At each of these processes, the defectivity is monitored pre- & post-process. CMP is an important step in chip manufacturing. However, the CMP steps introduce a significant amount of defects to the wafers. As mentioned above, the conventional workflow, shown in FIG. 1, has proven inadequate at removing contaminants in advanced node semiconductor manufacturing. The present disclosure relates to polisher rinse compositions and methods for processing a polished substrate on the polishing tool itself (i.e., without removing the polished substrate from the polishing tool). A general workflow for a method using polisher rinse compositions according to this disclosure is shown in FIG. 2 and will be described in detail later in this disclosure. Thus, the present disclosure discusses polisher rinse compositions and methods which not only reduce wafer defects but also provide various other electrochemical attributes that are critical for chip manufacturing.

In one aspect, the disclosure features a composition that includes at least one surface roughness controller; at least one pH adjuster; at least one particle dispersion agent; at least one chelating agent; at least one corrosion inhibitor; and an aqueous solvent, in which the composition has a pH of from about 7 to about 14.

In another aspect, this disclosure features a method that includes applying the composition disclosed herein (e.g., a polisher rinse composition) to a polished substrate containing ruthenium or an alloy thereof on a surface of the substrate in a polishing tool; and bringing a pad into contact with the surface of the substrate and moving the pad in relation to the substrate to form a rinse polished substrate.

This summary is provided to introduce a selection of concepts that are further described below in the detailed description. This summary is not intended to identify key or essential features of the claimed subject matter, nor is it intended to be used as an aid in limiting the scope of the claimed subject matter.

### DESCRIPTION OF DRAWINGS

FIG. 1 is a workflow diagram for a conventional CMP and P-CMP clean process.

FIG. 2 is a workflow diagram for an example of CMP and, optionally, a P-CMP clean process that incorporates a rinse composition described herein after the CMP process.

### DETAILED DESCRIPTION

Embodiments disclosed herein relate generally to rinse compositions and methods of using said compositions to wash substrates while the substrates are still on a polishing tool (e.g., a CMP polishing tool). In particular, the rinse compositions can be used to clean substrates directly after a CMP process and these rinse compositions are sometimes referred to herein as “rinse polish,” “buff chemical,” or “polisher rinse” compositions. In addition, the rinse compositions described herein can also find use in removing residue and/or contaminants from a substrate surface after an etching process, after an ashing process, after a plating process, or even in a conventional P-CMP cleaning process (i.e., one that takes place using a separate apparatus from the polishing tool).

As defined herein, residue and/or contaminants can include components present in a CMP polishing composition that has been used to polish the substrate to be cleaned (e.g., abrasives, molecular components, polymers, acids, bases, salts, surfactants, etc.), compounds produced during the CMP process as a result of chemical reactions between the substrate and the polishing composition and/or between components of the polishing composition, polishing pad debris particles (e.g., particles of a polymeric pad), polishing byproducts, organic or inorganic residues (e.g., those from a CMP slurry or CMP pad), substrate (or wafer) particles liberated during the CMP process, and/or any other removable materials that are known to deposit on a substrate after a CMP process.

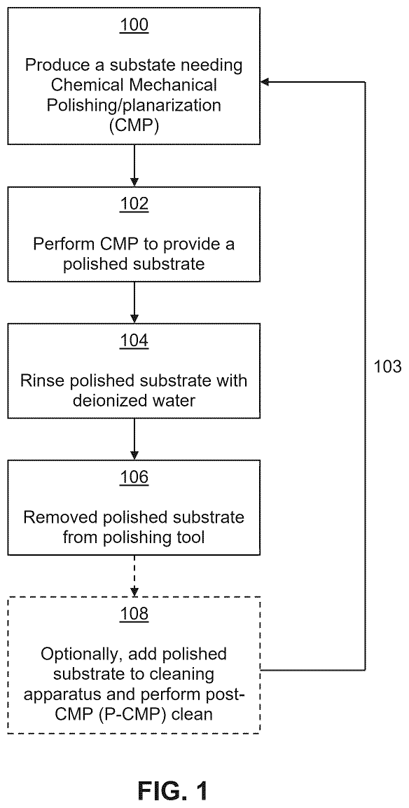

FIG. 1 is a workflow diagram for a conventional CMP and P-CMP clean process. The CMP step is typically performed in a polishing tool, which includes at least a polishing chamber (which includes polishing pads, polishing platens, and polishing heads), a cleaning chamber, and a drying chamber. In step 100, a substrate needing CMP is produced, e.g., after lithography and/or a material is deposited on the substrate. For example, the material that is deposited can be a metal or a dielectric material and the substrate can be a silicon wafer. In step 102, chemical mechanical planarization is performed in a polishing chamber of a polishing tool. For example, a wafer can be delivered to a polishing head in the polishing chamber and attached to the polishing head by vacuum before the CMP. The head can then bring the wafer to press onto a polishing pad, rotate the wafer, and apply an appropriate pressure to the wafer during CMP. CMP is performed in order to remove unnecessary deposited material and planarize the surface of the deposited material on the substrate. After the CMP, in step 104 the polished substrate (where “polished substrate” is defined as a substrate that has been polished using a CMP method) is rinsed with deionized (DI) water. This step is commonly believed to assist in washing/cleaning debris and residue left on the polished substrate and takes place in the polishing chamber of the polishing tool using milder polishing conditions (e.g., less downforce and rotational speed) directly after the polishing. However, without wishing to be bound by theory, it is believed that the drastic pH change from a CMP polishing composition (which can be highly acidic or highly alkaline) to DI water can cause some adverse chemistry to occur that can effectively cause a portion of the debris/residue to stick more tightly to the polished substrate surface. Subsequently, the now more tightly bound debris/residue are much more difficult to remove with a conventional P-CMP cleaning process once the polished substrate is removed from the polishing tool in step 106, transferred to a conventional P-CMP cleaning apparatus and cleaned in step 108. Optionally, after the conventional P-CMP cleaning in step 108, the polished substrate can be subjected to workflow 103 during which steps 100, 102, 104, 106, and 108 are repeated. If no further lithography/deposition and CMP is desired after step 108, the polished substrate can be used in a subsequent semiconductor manufacturing process.

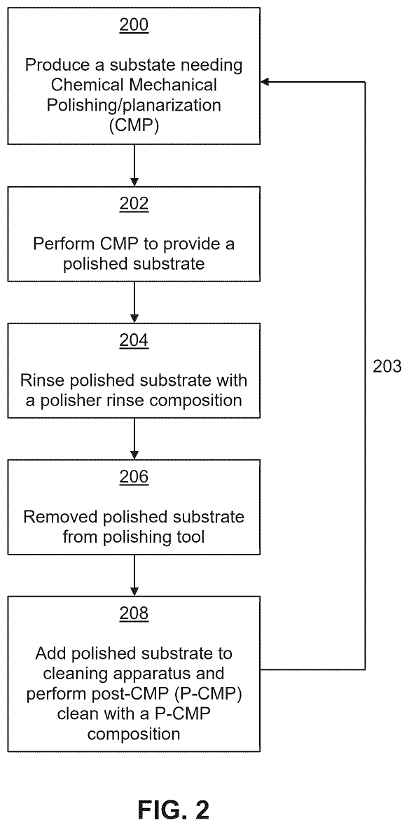

FIG. 2 is a workflow diagram for an example of a process of the present invention, which incorporates a polisher rinse composition described herein between the CMP process and an optional P-CMP process. In step 200, a substrate needing CMP is produced, e.g., after lithography and/or deposition of a material on the substrate. In step 202, chemical mechanical planarization is performed in a polishing chamber of a polishing tool. After the CMP, in step 204, the polished substrate is rinsed with a polisher rinse composition as disclosed herein. In some embodiments, a brief (e.g., a few seconds or less) DI water rinse is applied to the polished substrate directly after CMP. This brief DI water rinse can purge the equipment lines, the pad, and the polished substrate of any remaining CMP polishing composition and wash away any large debris. As mentioned herein, the process in step 204 is also referred to as a “rinse polishing process”. The rinse in step 204 is performed on the polished substrate while the polished substrate is still located in the polishing chamber of the polishing tool (e.g., attached to a polishing head in the polishing chamber and facing a polishing pad). In some embodiments, in step 204, the polisher rinse composition is applied to the polished substrate at the same time that the polishing pad is in contact with the polished substrate and moving in relation to the substrate (i.e., the polishing pad is being used as it would be during a CMP process). One of the main differences between a CMP step and the rinse polish in step 204 is that the polisher rinse composition being applied to the substrate includes substantially no abrasive particles, or a much smaller amount of abrasive particles (detailed below), than a CMP slurry composition would include. Thus, the material removed from the polished substrate in step 204 is primarily the debris/residue from the polishing step and not the deposited substrate material that is intended to be maintained on the polished substrate.

In some embodiments, the polisher rinse composition used on the polished substrate has a difference in pH value that is no more than about ±3 (e.g., no more than about ±2.5, no more than about ±2, no more than about ±1.5, no more than about ±1, or no more than about ±0.5) from the pH value of the CMP composition used to polish the polished substrate. In some embodiments, the pH value of the polisher rinse composition can be acidic if the pH value of the CMP composition used to polish the substrate was acidic or the pH value of the polisher rinse composition can be basic if the pH value of the CMP composition used to polish the substrate was basic. In some embodiments, the pH value of the polisher rinse composition can be substantially the same as the pH value of the CMP polishing slurry used to polish the polished substrate. Without being bound by theory, it is believed that the use of a similar pH value for the CMP polish composition and the polisher rinse composition can result in more effective removal of the debris/residue left behind on the polished substrate than simply using DI water as a rinse.

The rinsed polished substrate is removed from the polishing tool in step 206 and transferred to a cleaning apparatus for the conventional P-CMP cleaning in step 208. Optionally, after the conventional P-CMP cleaning in step 208, the polished substrate can be subjected to workflow 203 during which steps 200, 202, 204, 206, and 208 are repeated. If no further deposition and CMP is desired after step 208, the polished substrate can be used in a subsequent semiconductor manufacturing process.

In one or more embodiments, a polisher rinse composition described herein includes at least one surface roughness controller, at least one pH adjuster, at least one particle dispersion agent, at least one chelating agent, at least one corrosion inhibitor, and an aqueous solvent. In one or more embodiments, the composition has a pH of from about 7 to about 14. In one or more embodiments, a polisher rinse composition of the present disclosure can include from about 0.001% to about 5% by weight of the at least one surface roughness controller, from about 0.01% to about 20% by weight of the at least one pH adjuster, from about 0.005% to about 5% by weight of the at least one chelating agent, from about 0.001% to about 1% by weight of the at least one corrosion inhibitor, from about 0.01% to about 5% by weight of the at least one particle dispersion agent, and the remaining percent by weight (e.g., from about 59% to about 99.9% by weight) of aqueous solvent (e.g., deionized water).

In one or more embodiments, a POU polisher rinse composition of the present disclosure can include from about 0.001% to about 2% by weight of the at least one surface roughness controller, from about 0.01% to about 10% by weight of the at least one pH adjuster, from about 0.005% to about 2% by weight of the at least one chelating agent, from about 0.001% to about 2% by weight of the at least one corrosion inhibitor, from about 0.01% to about 2% by weight of the at least one particle dispersion agent, and the remaining percent by weight (e.g., from about 80% to about 99.972% by weight) of aqueous solvent (e.g., deionized water).

In one or more embodiments, a concentrated polisher rinse composition can include from about 0.01% to about 5% by weight of the at least one surface roughness controller, from about 0.1% to about 20% by weight of the at least one pH adjuster, from about 0.05% to about 5% by weight of the at least one chelating agent, from about 0.01% to about 5% by weight of the at least one corrosion inhibitor, from about 0.1% to about 5% by weight of the at least one particle dispersion agent, and the remaining percent by weight (e.g., from about 15% to about 99.72% by weight) of aqueous solvent (e.g., deionized water).

In one or more embodiments, the polisher rinse composition described herein can include at least one (e.g., two or three) surface roughness controller (e.g., an organic acid or a salt thereof). In one or more embodiments, the polisher rinse composition described herein can include a single surface roughness controller. In some embodiments, the at least one surface roughness controller can be selected from the group consisting of formic acid, gluconic acid, acetic acid, malonic acid, citric acid, propionic acid, malic acid, adipic acid, succinic acid, aspartic acid, ascorbic acid, lactic acid, oxalic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, potassium acetate, phenoxyacetic acid, benzoic acid, amino carboxylic acid, glycine, bicine, diglycolic acid, glyceric acid, tricine, alanine, histidine, valine, phenylalanine, proline, glutamine, aspartic acid, glutamic acid, arginine, lysine, tyrosine, and mixtures thereof. Without being bound by theory, it is believed that the surface roughness controller forms soluble complexes with metal oxides on a substrate surface and this may mitigate uncontrolled metal oxide growth and generate a more uniform and less rough substrate surface.

In one or more embodiments, the surface roughness controller is included in the polisher rinse composition in an amount from about 0.001% to about 5% by weight of the composition. For example, the surface roughness controller can be at least about 0.001% (e.g., at least about 0.002%, at least about 0.005%, at least about 0.01%, at least about 0.02%, at least about 0.05%, at least about 0.1%, at least about 0.2%, or at least about 0.5%) by weight to at most about 5% (e.g., at most about 4%, at most about 3%, at most about 2%, at most about 1%, at most about 0.9%, at most about 0.8%, at most about 0.7%, or at most about 0.6%) by weight of the polisher rinse composition described herein.

In one or more embodiments, the polisher rinse composition described herein can include at least one (e.g., two or three) pH adjuster. In one or more embodiments, the polisher rinse composition described herein can include a single pH adjuster. In one or more embodiments, the pH adjuster can be an acid (e.g., an organic or inorganic acid) or a base (e.g., an organic or inorganic base). In preferred embodiments, the pH adjuster is a base (e.g., an organic or inorganic base). In one or more embodiments, the pH adjuster is selected from the group consisting of tetrabutylammonium hydroxide, ethyltrimethylammonium hydroxide, tetrapropylammonium hydroxide, tetraethylammonium hydroxide, tetramethylammonium hydroxide, diethyldimethylammonium hydroxide, dimethyldipropylammonium hydroxide, benzyltrimethylammonium hydroxide, choline hydroxide, tris(2-hydroxyethyl)methylammonium hydroxide, bis(2-hydroxyethyl)-dimethylammonium hydroxide, bis(2-hydroxyethyl)-diethylammonium hydroxide, tetrakis(2-hydroxyethyl)ammonium hydroxide, ammonium hydroxide, monoethanolamine, diethanolamine, triethanolamine, dimethylethanolamine, 2-amino-2-methyl-1-propanol, 2-amino-2-methyl-1,3-propanediol, 2-amino-2-ethyl-1,3-propanediol, and any combinations thereof. In one or more embodiments, the pH adjuster is an alkylammonium hydroxide organic base that does not include covalently bound hydroxyl groups (e.g., does not include choline hydroxide or tris(2-hydroxyethyl)methylammonium hydroxide).

In one or more embodiments, the pH adjuster is included in the polisher rinse composition in an amount from about 0.01% to about 20% by weight of the composition. For example, the pH adjuster can be at least about 0.01% (e.g., at least about 0.02%, at least about 0.03%, at least about 0.04%, at least about 0.05%, at least about 0.07%, at least about 0.09%, or at least about 1%) by weight to at most about 20% (e.g., at most about 15%, at most about 12%, at most about 10%, at most about 8%, at most about 6%, at most about 4%, at most about 2%, or at most about 1%) by weight of the polisher rinse composition described herein.

In one or more embodiments, the polishing compositions described herein can be basic. When the polishing compositions are basic, the pH can range from at least about 7 (e.g., at least about 7.5, at least about 8, at least about 8.5, at least about 9, at least about 9.5, at least about 10, at least about 10.5, at least about 11, at least about 11.5, or at least about 12) to at most about 14 (e.g., at most about 13.5, at most about 13, at most about 12.5, at most about 12, at most about 11.5, at most about 11, at least about 10.5, or at most about 10). Without wishing to be bound by theory, it is believed that a polishing composition having a pH lower than 7 would significantly increase copper removal rate and corrosion, and a polishing composition having a pH higher than 14 would significantly increase the roughness and decrease the overall quality of a film contacted by such a composition. In order to obtain the desired pH, the relative concentrations of the ingredients in the polishing compositions described herein can be adjusted.

In one or more embodiments, the polisher rinse composition described herein can include at least one (e.g., two or three) particle dispersion agent. In one or more embodiments, the polisher rinse composition described herein can include a single particle dispersion agent. In one or more embodiments, the particle dispersion agent includes a water-soluble polymer. For example, the particle dispersion agent can be an anionic or a non-ionic polymer. In one or more embodiments, the water-soluble polymer is a non-ionic polymer selected from the group consisting of polyoxyethylene sorbitan monolaurate, polyoxyethylene sorbitan monopalminate, polyoxyethylene sorbitan monostearate, polyoxyethylene sorbitan monooleate, and mixtures thereof. In one or more embodiments, the water soluble polymer is an anionic polymer formed from one or more monomers selected from the group consisting of (meth)acrylic acid, maleic acid, acrylic acid, acrylamide, malic acid, methacrylic acid, vinyl phosphonic acid, vinyl phosphoric acid, vinyl sulfonic acid, allyl sulfonic acid, styrene sulfonic acid, acrylamidopropyl sulfonic acid, phosphonic acid, phosphoric acid, butadiene/maleic acid, caprolactam, etherimide, 2-ethyl-2-oxazoline, N-iso-propylacrylamide, sodium phosphinite, and co-formed products thereof, and sodium, potassium, and ammonium salts thereof. In one or more embodiments, the water soluble polymer is selected from the group consisting of poly(4-styrenylsulfonic) acid (PSSA), polyacrylic acid (PAA), poly(vinylphosphonic acid) (PVPA), poly(2-acrylamido-2-methyl-1-propanesulfonic acid), poly(N-vinylacetamide) (PNVA), polyethylenimine (PEI), anionic poly(methyl methacrylate)(PMMA), anionic polyacrylamide (PAM), polyaspartic acid (PASA), anionic poly(ethylene succinate)(PES), anionic polybutylene succinate (PBS), poly(vinyl alcohol)(PVA), 2-propenoic acid copolymer with 2-methyl-2-((1-oxo-2-propenyl)amino)-1-propanesulfonic acid monosodium salt and sodium phosphinite, 2-propenoic acid copolymer with 2-methyl-2-((1-oxo-2-propenyl)amino)-1-propanesulfonic acid monosodium salt and sodium hydrogen sulfite sodium salt, 2-acrylamido-2-methyl-1-propanesulfonic acid-acrylic acid copolymer, poly(4-styrenesulfonic acid-co-acrylic acid-co-vinylphosphonic acid) terpolymer, and mixtures thereof. Without being bound by theory, it is believed that the anionic polymer or the non-ionic polymer can solubilize hydrophobic polishing materials and other defects on a wafer surface and facilitate their removing during a cleaning process after a polishing step via CMP.

In some embodiments, the water-soluble polymer is in an amount of from about 0.01% to about 5% by weight of the polisher rinse composition described herein. For example, the water soluble polymer can be at least about 0.01% (e.g., at least about 0.02%, at least about 0.05%, at least about 0.1%, at least about 0.2%, at least about 0.3%, at least about 0.4%, at least about 0.5%, or at least about 0.7%) by weight to at most about 5% (e.g., at most about 4%, at most about 3%, at most about 2%, at most about 1%, at most about 0.9%, or at most about 0.8%) by weight of the polisher rinse composition described herein.

In one or more embodiments, the polisher rinse composition described herein can include at least one (e.g., two or three) chelating agent. In one or more embodiments, the polisher rinse composition described herein can include a single chelating agent. In one or more embodiments, the at least one chelating agent can be any molecule containing multiple carboxylic or phosphonic acids, or the combination of both functional groups. In some embodiments, the at least one chelating agent can be an acid or a salt thereof selected from the group consisting of nitric acid, ethylenediamine, N,N,N′,N″,N″-pentamethyldiethylenetriamine, ethylenediaminetetraacetic acid, diethylenetriaminepentaacetic acid, hydroxyethylidene diphosphonic acid, aminotris(methylenephosphonic) acid, ethylenediamine tetra(methylene phosphonic acid), 1,2-diaminocyclohexanetetraacetic acid monohydrate, diethylenetriamine, triethylenetetramine, tetraethylenepentamine, aminocthylethanolamine, and salts and mixtures thereof. Without being bound by theory, it is believed that the chelating agent can increase the dissolution and removal of metal byproducts left behind on a polished substrate.

In one or more embodiments, the at least one chelating agent can be at least about 0.005% (e.g., at least about 0.006%, at least about 0.008%, at least about 0.01%, at least about 0.02%, at least about 0.05%, at least about 0.08%, at least about 0.1%, at least about 0.2%, or at least about 0.5%) to at most about 5% (e.g., at most about 4%, at most about 3%, at most about 2%, at most about 1%, at most about 0.9%, at most about 0.8%, at most about 0.7%, at most about 0.6%, or at most about 0.5) by weight of the cleaning composition described herein.

In one or more embodiments, the polisher rinse composition described herein can include at least one (e.g., two or three) corrosion inhibitor. In one or more embodiments, the polisher rinse composition described herein can include a single corrosion inhibitor. In one or more embodiments, the corrosion inhibitor is a heterocyclic compound, such as a heterocyclic compound containing at least two (e.g., three or four) ring nitrogen atoms. In one or more embodiments, the corrosion inhibitor is an azole, such as a triazole (e.g., a benzotriazole), a tetrazole, a pyrazole, an imidazole, or a thiadiazole, each of which is optionally substituted with one or more substituents (e.g., halo, amino, C₁-C₁₀ alkyl, C₁-C₁₀ arylalkyl, C₁-C₁₀ haloalkyl, or aryl). In one or more embodiments, the corrosion inhibitor is a purine (e.g., 9H-purine, xanthine, hypoxanthine, guanine, and isoguanine) or a pyrimidine (e.g., cytosine, thymine, and uracil). In one or more embodiments, the corrosion inhibitor is selected from the group consisting of tetrazole, benzotriazole, tolyltriazole, 1-methyl benzotriazole, 4-methyl benzotriazole, 5-methyl benzotriazole, 1-ethyl benzotriazole, 1-propyl benzotriazole, 1-butyl benzotriazole, 5-butyl benzotriazole, 1-pentyl benzotriazole, 1-hexyl benzotriazole, 5-hexyl benzotriazole, 5,6-dimethyl benzotriazole, 5-chloro benzotriazole, 5,6-dichloro benzotriazole, 1-(chloromethyl)-1H-benzotriazole, chloroethyl benzotriazole, phenyl benzotriazole, benzyl benzotriazole, aminotriazole, aminobenzimidazole, pyrazole, imidazole, aminotetrazole, adenine, xanthine, cytosine, thymine, uracil, 9H-purine, guanine, isoguanine, hypoxanthine, benzimidazole, thiabendazole, 1,2,3-triazole, 1,2,4-triazole, 1-hydroxybenzotriazole, 2-methylbenzothiazole, 2-aminobenzimidazole, 2-amino-5-ethyl-1,3,4-thiadiazole, 3,5-diamino-1,2,4-triazole, 3-amino-5-methylpyrazole, 4-amino-4H-1,2,4-triazole, and combinations thereof. Without wishing to be bound by theory, it is believed that the azole compounds can be used as a corrosion inhibitor in the polisher rinse compositions described herein to reduce the removal of certain materials (e.g., metals or dielectric materials) during the cleaning process.

In one or more embodiments, the corrosion inhibitor is included in the polisher rinse composition in an amount from about 0.001% to about 5% by weight of the composition. For example, the corrosion inhibitor can be at least about 0.001% (e.g., at least about 0.002%, at least about 0.004%, at least about 0.006%, at least about 0.008%, at least about 0.01%, at least about 0.02%, at least about 0.04%, at least about 0.06%, or at least about 0.08%) by weight to at most about 5% (e.g., at most about 4%, at most about 3%, at most about 2%, at most about 1%, at most about 0.8%, at most about 0.6%, at most about 0.4%, at most about 0.2%, or at most about 0.1%) by weight of the polisher rinse composition described herein.

In one or more embodiments, the polisher rinse composition described herein can further include at least one (e.g., two or three) low-k removal rate inhibitor. In one or more embodiments, the polisher rinse composition described herein can include a single low-k removal rate inhibitor. In one or more embodiments, the low-k removal rate inhibitor is a non-ionic surfactant. In one or more embodiments, the low-k removal rate inhibitor is selected from the group consisting of alcohol alkoxylates, alkylphenol alkoxylates (e.g., 4-nonylphenyl-polyethylene glycol), tristyrylphenol alkoxylates (e.g., tristyrylphenol ethoxylate), sorbitan ester alkoxylates (e.g., polysorbates), polyalkoxylates (e.g., polyethylene glycol), polyalkylene oxide block copolymers (e.g., C₁₂-C₁₄ tert-alkylamines ethoxylated propoxylated), alkoxylated diamines, and mixtures thereof.

Among the above nonionic surfactants, alcohol alkoxylate is preferable. The alcohol alkoxylate is preferably the compound represented by General Formula (b) below.

$$R - {L}^{1} - {( {L}^{2} O )}_{n} - H \qquad ( b )$$

In General Formula (b), R represents an alkyl group. L¹ represents a single bond, an oxygen atom, or an alkylene group that may have an oxygen atom. L² represents an alkylene group having two or three carbon atoms. A plurality of L² groups may be identical to or different from one another. n represents a number of two or more. In General Formula (b) above, the number of carbon atoms included in the alkyl group represented by R is preferably 5 to 25, is more preferably 8 to 20, and is further preferably 10 to 18. The above alkyl group may be either linear or branched. The number of carbon atoms included in the alkylene group that may have an oxygen atom, which is represented by L¹, is preferably 1 to 20, is more preferably 1 to 10, and is further preferably 1 to 5. n is preferably 3 to 50, is more preferably 4 to 30, and is further preferably 6 to 20. Examples of the alkylene group that may have an oxygen atom include —O—CH₂—CH₂— and —O—CH₂—CH₂—CH₂—. In one or more embodiments, the hydrophile-lipophile balance (HLB) value of the nonionic surfactant is preferably 3 to 20, is more preferably 8 to 17, and is further preferably 8 to 15 in order to enhance the advantageous effects of the present invention. The HLB value is the value calculated using Griffin's formula (20×Mw/M, where Mw represents the molecular weight of a hydrophilic portion, and M represents the molecular weight of the nonionic surfactant). Depending on the situation, the catalog value or a value calculated using another method may be used. The closer to 20 the HLB value, the more hydrophilic the nonionic surfactant. The closer to 0 the HLB value, the more lipophilic the nonionic surfactant.

In one or more embodiments, the nonionic surfactant is a polymer having a number average molecular weight of at least about 500 g/mol, or at least about 1,000 g/mol, or at least about 2,500 g/mol, or at least about 5,000 g/mol, or at least about 7,500 g/mol, or at least about 10,000 g/mol. In one or more embodiments, the nonionic surfactant is a polymer having a number average molecular weight of at most about 1,000,000 g/mol, or at most about 750,000 g/mol, or at most about 500,000 g/mol, or at most about 250,000 g/mol, or at most about 100,000 g/mol. In one or more embodiments, the alkoxylate groups of the alkoxylated nonionic surfactants are ethoxylate, propoxylate, or a combination of ethoxylate and propoxylate groups. Without wishing to be bound by theory, it is surprising that a nonionic surfactant (such as those described above) can be used as a low-k removal rate inhibitor in the composition described herein to reduce or minimize the removal rate of a low-k film (e.g., a carbon doped silicon oxide film) in a semiconductor substrate.

In one or more embodiments, the low-k removal rate inhibitor, if present, is included in the polisher rinse composition in an amount from about 0.001% to about 5% by weight of the composition. For example, the low-k removal rate inhibitor can be at least about 0.001% (e.g., at least about 0.002%, at least about 0.004%, at least about 0.006%, at least about 0.008%, at least about 0.01%, at least about 0.02%, at least about 0.04%, at least about 0.06%, or at least about 0.08%) by weight to at most about 5% (e.g., at most about 4%, at most about 3%, at most about 2%, at most about 1%, at most about 0.8%, at most about 0.6%, or at most about 0.4%) by weight of the polisher rinse composition described herein.

In some embodiments, the polisher rinse composition described herein can include an aqueous solvent (e.g., deionized water), such as water. In some embodiments, the aqueous solvent (e.g., deionized water) is in an amount of from at least about 15% (e.g., at least about 20%, at least about 25%, at least about 30%, at least about 40%, at least about 45%, at least about 50%, at least about 55%, at least about 60%, at least about 65%, at least about 70%, at least about 75%, at least about 80%, at least about 85%, at least about 90%, at least about 92%, at least about 94%, at least about 95%, or at least about 97%) by weight to at most about 99% (e.g., at most about 98%, at most about 96%, at most about 94%, at most about 92%, at most about 90%, at most about 85%, at most about 80%, at most about 75%, at most about 70%, or at most about 65%) by weight of the cleaning composition described herein.

An optional oxidizer can be added when diluting a concentrated polisher rinse composition to form a POU polisher rinse. The oxidizer can be selected from the group consisting of hydrogen peroxide, ammonium persulfate, silver nitrate (AgNO₃), ferric nitrates or chlorides, per acids or salts, ozone water, potassium ferricyanide, potassium dichromate, potassium iodate, potassium bromate, potassium periodate, periodic acid, vanadium trioxide, hypochlorous acid, sodium hypochlorite, potassium hypochlorite, calcium hypochlorite, magnesium hypochlorite, potassium permanganate, other inorganic or organic peroxides, and mixtures thereof. In one embodiment, the oxidizer is hydrogen peroxide. In one or more embodiments, the polisher rinse composition does not include an oxidizer.

In some embodiments, the oxidizer is in an amount of from at least about 0.05% (e.g., at least about 0.1%, at least about 0.2%, at least about 0.4%, at least about 0.5%, at least about 1%, at least about 1.5%, at least about 2%, at least about 2.5%, at least about 3%, at least about 3.5%, at least about 4%, or at least about 4.5%) by weight to at most about 5% (e.g., at most about 4.5%, at most about 4%, at most about 3.5%, at most about 3%, at most about 2.5%, at most about 2%, at most about 1.5%, at most about 1%, at most about 0.5%, or at most about 0.1%) by weight of the polisher rinse composition described herein. In some embodiments, without wishing to be bound by theory, it is believed that the oxidizer can help remove metal films by forming a metal complex with the chelating agent so that the metal can be removed during the CMP process. In some embodiments, without wishing to be bound by theory, it is believed that the oxidizer can help passivate a metal surface by forming an oxide film that can increase the corrosion resistance of the metal film. In some embodiments, the oxidizer may reduce the shelf life of a polisher rinse composition. In such embodiments, the oxidizer can be added to the polisher rinse composition at the point of use right before a rinse polishing process.

In one or more embodiments, the polisher rinse composition described herein can optionally include a relatively small amount of abrasive particles. In some embodiments, the abrasive particles can include silica, ceria, alumina, titania, and zirconia abrasives. In some embodiments, the abrasive particles can include non-ionic abrasives, surface modified abrasives, or negatively/positively charged abrasives. In some embodiments, the polisher rinse composition can include abrasive particles in an amount of from at least 0.001% (e.g., at least about 0.005%, at least about 0.01%, at least about 0.05%, or at least about 0.1%) by weight to at most about 0.2% (e.g., at most about 0.15%, at most about 0.1%, at most about 0.05%, or at most about 0.01%) by weight of the polisher rinse composition described herein. In some embodiments, the polisher rinse composition described herein can be substantially free of abrasive particles.

In one or more embodiments, the composition is substantially free of abrasive particles. As used herein, an ingredient that is “substantially free” from a composition refers to an ingredient that is not intentionally added into the cleaning composition. In some embodiments, the composition described herein can have at most about 2000 ppm (e.g., at most about 1000 ppm, at most about 500 ppm, at most about 250 ppm, at most about 100 ppm, at most about 50 ppm, at most about 10 ppm, or at most about 1 ppm) of abrasive particles. In some embodiments, the composition described herein can be completely free of abrasive particles.

In one or more embodiments, the polisher rinse composition described herein can be substantially free of one or more of certain ingredients, such as organic solvents, pH adjusting agents, quaternary ammonium compounds (e.g., salts such as tetraalkylammonium salts or hydroxides such as tetraalkylammonium hydroxides (e.g., TMAH)), alkali bases or inorganic bases (such as alkali hydroxides), fluorine containing compounds (e.g., fluoride compounds or fluorinated compounds (e.g., fluorinated polymers/surfactants)), silicon containing compounds such as silanes (e.g., alkoxysilanes), nitrogen-containing compounds (e.g., amino acids, amines, imines (e.g., amidines such as 1,8-diazabicyclo[5.4.0]-7-undecene (DBU) and 1,5-diazabicyclo[4.3.0]non-5-ene (DBN)), amides, or imides), salts (e.g., halide salts or metal salts), polymers (e.g., non-ionic, cationic, anionic, or water-soluble polymers), surfactants (e.g., acetylenic surfactants, cationic surfactants, anionic surfactants, non-polymeric surfactants, or non-ionic surfactants), plasticizers, oxidizing agents (e.g., H₂O₂ and/or periodic acid), corrosion inhibitors (e.g., azole or non-azole corrosion inhibitors), electrolytes (e.g., polyelectrolytes), dienoic acids (e.g., sorbic acid), and/or abrasives (e.g., polymeric abrasives, fumed silica, ceria abrasives, non-ionic abrasives, surface modified abrasives, negatively/positively charged abrasives, or ceramic abrasive composites). The halide salts that can be excluded from the compositions include alkali metal halides (e.g., sodium halides or potassium halides) or ammonium halides (e.g., ammonium chloride), and can be fluorides, chlorides, bromides, or iodides. In some cases, combinations of ingredients can be excluded from the polisher rinse composition described herein (e.g., anionic polymers and anionic surfactants; or anionic polymers, anionic surfactants, and abrasives; or oxidizing agents and salts; or oxidizing agents, salts, and abrasives; or anionic polymers, oxidizing agents, and salts; or anionic polymers, oxidizing agents, salts, and abrasives; or organic solvents and polymers; or organic solvents, polymers, and abrasives). As used herein, an ingredient that is “substantially free” from a polisher rinse composition refers to an ingredient that is not intentionally added into the composition. In some embodiments, the polisher rinse composition described herein can have at most about 2000 ppm (e.g., at most about 1000 ppm, at most about 500 ppm, at most about 250 ppm, at most about 100 ppm, at most about 50 ppm, at most about 10 ppm, or at most about 1 ppm) of one or more of the above ingredients. In some embodiments, the polisher rinse composition described herein can be completely free of one or more of the above ingredients.

As applied to polisher rinse operations, the polisher rinse compositions described herein are usefully employed to remove contaminants present on a substrate surface directly after a CMP processing step while the polished substrate is still located within the polishing chamber of the polishing tool. In one or more embodiments, the contaminants can be at least one selected from the group consisting of abrasives, particles, organic residues, polishing byproducts, slurry byproducts, slurry induced organic residues, and inorganic polished substrate residues. In one or more embodiments, the polisher rinse compositions of the present disclosure can be employed to remove organic residues containing organic particles which are insoluble in water and thus remain on the wafer surface post the CMP polishing step. Without being bound by theory, it is believed that the organic particles can be generated from CMP polishing composition components that deposit on a substrate surface after polishing and are insoluble and thus stick as contaminants on the wafer surface. The presence of the contaminants described above results in defect counts on the wafer surface. These defect counts, when analyzed on a defect measuring tool such as the AIT-XUV tool from KLA Tencor Company, provide the total defect count (TDC) that is a sum of all the individual defect counts. In one or more embodiments, the compositions described herein remove at least about 30% (e.g., at least about 50%, at least about 75%, at least about 80%, at least about 90%, at least about 95%, at least about 98%, at least about 99%, at least about 99.5%, at least about 99.9%) of the total defect count (TDC) remaining on a substrate surface after a polishing/CMP process.

In some embodiments, this disclosure features a method of rinse polishing a previously polished substrate (e.g., a wafer polished by a CMP composition). The method can include contacting, within a polishing tool, the polished substrate with a polisher rinse composition described herein. In some embodiments, the substrate described herein (e.g. a wafer) can include at least one material selected from the group consisting of tungsten, titanium nitride, silicon carbide, silicon oxide (e.g., TEOS), low-K and ultra low-k materials (e.g., doped silica and amorphous carbon), silicon nitride, copper, cobalt, ruthenium, molybdenum, and polysilicon on a substrate surface.

In rinse polishing operations, the polisher rinse composition can be applied to the polished substrate in the same way that a CMP composition would have been applied to the previously polished substrate (e.g., the polisher rinse composition is applied while the polished substrate is in contact with a polishing pad). In some embodiments, the conditions can be milder during a rinse polishing process than the conditions used during a CMP process. For example, the down force, rotational speed, or time in a rinse polishing process can be less than the same conditions used in the prior CMP process.

In some embodiments, the down force used in a rinse polishing process is from at least about 5% (e.g., at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75%) to at most about 90% (e.g., at most about 85%, at most about 80%, at most about 75%, at most about 70%, or at most about 65%) of the down force used in a CMP process (e.g., in a preceding CMP process). In one or more embodiments, the down force used in a CMP process is from about 1 psi to about 4 psi. In some embodiments, a polishing pad is brought into contact with the previously polished substrate, but substantially no down force is applied to the previously polished substrate during the rinse polishing process. In some embodiments, the down force used in a rinse polishing process is substantially the same as the down force used in the prior CMP operation.

In some embodiments, the rinse time used in a rinse polishing process is from at least about 10% (e.g., at least about 15%, at least about 20%, at least about 25%, at least about 30%, or at least about 35%) to at most about 50% (e.g., at most about 45%, at most about 40%, at most about 35%, at most about 30%, or at most about 25%) of the rinse time used in a CMP process (e.g., in a preceding CMP process). In one or more embodiments, the rinse time used in a CMP process is from about 2 seconds to about 20 seconds. In some embodiments, the time used in a rinse polishing process is substantially the same as the down force used in the prior CMP operation.

In some embodiments, the polisher rinse composition described herein can be used as a post-CMP cleaner in a post-CMP cleaning step 208 (i.e., a cleaning step that takes place on a cleaning apparatus different from the polishing tool). In one or more embodiments, when a polisher rinse composition is used as a post-CMP cleaner it may not include an oxidizing agent (e.g., H₂O₂). In post-CMP cleaning applications, the polisher rinse composition can be applied in any suitable manner to the substrate to be cleaned. For example, the composition can be used with a large variety of conventional cleaning tools and techniques (e.g., brush scrubbing, spin rinse dry, etc.). In some embodiments, a cleaning tool or apparatus suitable for a post-CMP cleaning process is a tool (e.g., a brush scrubber or a spin rinse dryer) without a polishing equipment (e.g., a polishing pad, a polishing platen, and/or a polishing head). In some embodiments, the substrate to be cleaned (e.g. a wafer) in the post CMP cleaning step can include at least one material selected from the group consisting of tungsten, titanium nitride, silicon carbide, silicon oxide (e.g., TEOS), silicon nitride, copper, cobalt, ruthenium, molybdenum, and polysilicon on a substrate surface.

In one or more embodiments, the present disclosure provides a cleaning composition that can be diluted with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 800, or up to a factor of 1000. In other embodiments, the present disclosure provides a point-of-use (POU) composition comprising the above-described cleaning composition, water, and optionally an oxidizer for use on a substrate.

The extent of dilution can depend on the type of POU composition. For example and without limitation, a POU polisher rinse composition can be obtained by diluting a concentrated composition with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 800, or up to a factor of 1000. In some embodiments, the POU polisher rinse composition can be obtained by diluting a concentrated composition with a solvent (e.g., water) prior to use by a factor of at least about 2 (e.g., at least about 3, at least about 4, at least about 5, at least about 6, at least about 7, at least about 8, at least about 9, at least about 10, at least about 12, at least about 14, at least about 16, or at least about 18) to a factor of at most about 200 (e.g., at most about 150, at most about 100, at most about 50, at most about 20, at most about 19, at most about 18, at most about 17, at most about 16, at most about 15, at most about 14, at most about 13, at most about 12, at most about 11, at most about 10, at most about 9 at most about 8, at most about 7, at most about 6, or at most about 5).

A POU post-CMP composition can have a concentration of at least one (e.g., two, three, or more) component, in which its concentration can be compared to a concentration of the corresponding component in a concentrated composition or in a POU polisher rinse composition. For example and without limitation, if the POU polisher rinse composition is obtained by diluting a concentrated composition by a dilution factor of about 10 (for a 10× diluted polisher rinse composition), then the POU post-CMP composition can be obtained by diluting that same concentrated composition by a dilution factor of about 1000 (for a 1000× diluted post-CMP composition). Alternatively, the POU post-CMP composition can be obtained by diluting a POU polisher rinse composition. For example, and without limitation, if the POU polisher rinse is a 10× diluted polisher rinse composition (as described above), then a 1000× diluted post-CMP composition can be obtained by further diluting the 10× diluted polisher rinse composition by a dilution factor of about 100. Other dilution factors with any cleaning composition (e.g., any described herein) are contemplated.

In another non-limiting example, a POU post-CMP composition can be obtained by diluting a concentrated composition with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 800, or up to a factor of 1000. In some embodiments, the POU post-CMP composition can be obtained by diluting a concentrated composition with a solvent (e.g., water) prior to use by a factor of at least about 50 (e.g., at least about 60, at least about 70, at least about 80, at least about 90, at least about 100, at least about 150, at least about 200, at least about 250, at least about 300, at least about 350, at least about 400, at least about 450) to a factor of at most about 1000 (e.g., at most about 900, at most about 800, at most about 700, at most about 600, at most about 500, at most about 450, at most about 400, at most about 350, at most about 300, at most about 250, at most about 200, at most about 150, or at most about 100).

In some embodiments, a POU post-CMP composition can be obtained by diluting a POU polisher rinse composition with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 500, or up to a factor of 800, or up to a factor of 1000.

Without wishing to be bound by theory, it is believed that the post-CMP composition described herein can include a much smaller concentration/amount of a single chemical material or overall chemical materials, as compared to the polisher rinse composition to be used with the post-CMP composition, and achieve unexpected performance (e.g., better cleaning efficacy, improved defect count or percentage of residue defects, and/or lower corrosion of exposed materials on a substrate) when such a polisher rinse composition and post-CMP composition are used in combination during a cleaning process.

In some embodiments, the method that uses a polisher rinse composition described herein can further include producing a semiconductor device from the substrate treated by the cleaning composition through one or more steps. For example, photolithography, ion implantation, dry/wet etching, plasma etching, deposition (e.g., PVD, CVD, ALD, ECD), wafer mounting, die cutting, packaging, and testing can be used to produce a semiconductor device from the substrate treated by the cleaning composition described herein.

The specific examples below are to be construed as merely illustrative, and not limitative of the remainder of the disclosure in any way whatsoever. Without further elaboration, it is believed that one skilled in the art can, based on the description herein, utilize the present invention to its fullest extent.

### EXAMPLES

Examples are provided to further illustrate the capabilities of the polisher rinse compositions and methods of the present disclosure. The provided examples are not intended and should not be construed to limit the scope of the present disclosure. Any percentages listed are by weight (wt %) unless otherwise specified. The examples shown herein are representative and cannot encompass the complete broad scope of this invention disclosure.

The general cleaning compositions (e.g., polisher rinse) used in the examples are shown in Table 1 below. The specifics details on the differences in the compositions tested will be explained in further detail when discussing the respective examples.

TABLE 1

| | |
|---|---|
| | % By Weight of |
| Component | Composition |

| Surface Roughness Controller | 0.005-5 | |
|---|---|---|
| Organic Base | 0.01-20 | |
| Particle Dispersion Agent | 0.01-5 | |
| Low-k Inhibitor Removal Rate Inhibitor | 0.005-5 | (if used) |
| Chelating Agent | 0.005-5 | |
| Corrosion Inhibitor | 0.001-1 | |
| Oxidizer (H₂O₂) | 0.001-10 | (if used) |

| | |
|---|---|
| Solvent (DI Water) | 60-99.99 |
| pH | 7-14 |

### Example 1—Comparison of Use of Organic Base Only Versus Use of a Blend of Organic Base and Inorganic Base on Cu Static Etch Rate (SER) and Copper Oxide and Ruthenium Oxide Dissolution

In this Example, the effect of using solely an organic base in a polisher rinse composition versus using a blend of organic base and inorganic base at 1:1 wt % was tested. Each composition tested had the same pH and the organic base used in this example was a tetraalkylammonium hydroxide with at least one alkyl group having at least two carbon atoms. The Cu SER was measured by incubating a copper coupon statically in the polisher rinse solutions statically at 45° C. for five minutes and then measuring the copper concentration of the supernatant using Inductively Coupled Plasma Mass Spectrometry (ICP-MS). The copper oxide (Cu₂O) and ruthenium oxide (RuO₂) dissolution were measured by adding 50 mg of the oxide powder to 50 g of polisher rinse solution under static room temperature conditions for five minutes and then measuring the copper or ruthenium concentration of the supernatant using ICP-MS. Table 2 below shows the results of the testing.

TABLE 2

| | | Blend of Organic Base |
|---|---|---|
| | Only Organic Base | and Inorganic Base |
| Cu SER (ppb) | 15 | 15 |
| Cu₂O Dissolution (ppb) | 2568 | 1674 |
| RuO₂ Dissolution (ppb) | 25 | 8 |

The results show that the Cu SER was maintained whether using only the organic base or a blend of organic base and inorganic base. However, surprisingly, using only the organic base resulted in significantly higher dissolution of copper and ruthenium oxides when compared with a blended organic base and inorganic base. Higher dissolution of copper and ruthenium oxides is an important feature of an effective polisher rinse composition because the oxides are common CMP byproducts that contaminate the surface of substrates and can prevent further processing of the substrates.

### Example 2—Comparison of Polisher Rinse Composition without Oxidizer and with Oxidizer

In this Example, the addition of oxidizer (i.e., H₂O₂) was evaluated for SER on copper, cobalt, and ruthenium coupons coupons and also for dissolution of the corresponding metal oxides. The SER and oxide dissolution tests were performed as described above in Example 1. Additionally, electrochemical data was also collected on coupons of copper, ruthenium and cobalt. To collect the electrochemical data a metal coupon was mounted on an electrochemical workstation (a potentiostat) as a working electrode, along with a reference electrode (Ag/AgCl) and counter electrode (graphite). All the electrodes were immersed in the polisher rinse solutions and then a potential was applied to collect the Tafel Plot, from which the Ecorr and Icorr values were determined. The results are shown in Table 3 below.

TABLE 3

| | No Oxidizer | 1 wt. % Oxidizer |
|---|---|---|
| Cu SER (Å/min) | <1 | <1 |
| Co SER (Å/min) | 2.4 | 1.8 |
| Ru SER (Å/min) | <0.1 | <0.1 |
| Cu₂O (ppb) | 1964 | 9628 |
| Co₃O₄ (ppb) | 26 | 69 |
| RuO₂ (ppb) | 41 | 54 |
| ΔEcorr (Cu − Co) | 476.7 | 28.1 |
| ΔEcorr (Cu − Ru) | 58.1 | 48.5 |

The results show that the SER of both copper, cobalt and ruthenium are negligible and relatively unchanged upon the addition of oxidizer. Additionally, the addition of the oxidizer led to significant increases in the dissolution of the metal oxides believed to be components of the residue and contamination left behind on a substrate surface after a CMP process. Increases in the values for the Ecorr electrochemical data on copper, cobalt, and ruthenium with the addition of oxidizer (data not shown) demonstrates that a surface passivation layer on each metal becomes thicker, which leads to increased metal surface protection from corrosion. Further, and surprisingly, the ΔEcorr (Cu—Co) is greatly reduced when an oxidizer is added, indicating that galvanic corrosion between Cu and Co features on the substrate is decreased leading to reduced potential for defective performance.

### Example 3—Comparison of Ruthenium and Copper Residue Level after CMP

In this Example coupons containing a Cu-Black Diamond (CuBD) Array were first polished with a commercial barrier polishing composition. After the CMP step the coupons were analyzed by Time of Flight Secondary Ion Mass Spectrometry (ToF-SIMS) for ruthenium and copper contamination under three conditions: (1) without any surface cleaning, (2) after using deionized water (DIW) as polisher rinse composition, and (3) after using a polisher rinse composition as described in Table 1. The results are shown in Table 4 below.

TABLE 4

| | Without | DIW as | Polisher Rinse |
|---|---|---|---|
| | Surface | Polisher Rinse | Composition |
| | Cleaning | Composition | According to Table 1 |
| Ru Signal Intensity | 0.24 | 0.28 | 0.08 |
| Cu Signal Intensity | 0.44 | N/A | 0.07 |

The results show that the use of a polisher rinse composition according to Table 1 drastically reduced the level of ruthenium and copper contamination on the CuBD coupons after they were polished with a barrier slurry.

### Example 4—Use of Polisher Rinse Composition for Both On-Platen Cleaning and Post-CMP Cleaning

In this Example copper blanket wafers were first polished with a commercial barrier CMP polishing slurry. Following the CMP step, the polished wafers were subjected to a polisher rinse operation (e.g., on-platen cleaning) using one of two polisher rinse compositions according to the Table 1. Polisher Rinse Composition 1 (PR1) did not include an oxidizing agent, while Polisher Rinse Composition 2 (PR2) included hydrogen peroxide as an oxidizing agent and a different alkylammonium hydroxide organic base than that included in (PR1). Both PR1 and PR2 did not include a low-k removal rate inhibitor and were used at 20× dilution from a concentrated formulation. Following the polisher rinse operation, the rinse polished substrate was taken from the polishing tool and placed in a brush box cleaning tool using brush scrubbers where a post-CMP clean operation was performed on the rinse polished substrate using either PR1 at a 100× dilution of the concentrated formulation or a commercial copper cleaner at a 100× dilution of a concentrated formulation. The defect counts after both the polisher rinse operation and the post-CMP clean operation were measured using a KLA Puma 9650 instrument that detects the defects by incident polarized light beam scattering. The results are presented in Table 5 below.

TABLE 5

| | | PR 2 (w/commercial pCMP |
|---|---|---|
| | PR 1 | clean) |
| Defect Counts After Polisher | 2721 | 2018 |
| Rinse Operation | | |
| Defect Counts After pCMP | 27 | 880 |
| Operation | | |

The results show, surprisingly, that PR1 when used as both a polisher rinse composition and a post-CMP clean composition vastly outperformed the defect reductions achieved by the similar PR2 that was paired with a commercial copper post-CMP clean. This result demonstrates the possibility of using a concentrated polisher rinse composition of the present disclosure as a two in one solution for both rinse polishing operations and post-CMP clean operations.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A composition, comprising:
at least one surface roughness controller;
at least one pH adjuster;
at least one particle dispersion agent;
at least one chelating agent;
at least one corrosion inhibitor; and
an aqueous solvent;
wherein the composition has a pH of from about 7 to about 14.

2. The composition of claim 1, wherein the at least one surface roughness controller comprises an organic acid or a salt thereof selected from the group consisting of formic acid, gluconic acid, acetic acid, malonic acid, citric acid, propionic acid, malic acid, adipic acid, succinic acid, aspartic acid, ascorbic acid, lactic acid, oxalic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, potassium acetate, phenoxyacetic acid, benzoic acid, amino carboxylic acid, glycine, bicine, diglycolic acid, glyceric acid, tricine, alanine, histidine, valine, phenylalanine, proline, glutamine, aspartic acid, glutamic acid, arginine, lysine, tyrosine, and mixtures thereof.

3. The composition of claim 1, wherein the at least one surface roughness controller is in an amount of from about 0.001% to about 5% by weight of the composition.

4. The composition of claim 1, wherein the at least one pH adjuster is selected from the group consisting of tetrabutylammonium hydroxide, ethyltrimethylammonium hydroxide, tetrapropylammonium hydroxide, tetraethylammonium hydroxide, tetramethylammonium hydroxide, diethyldimethylammonium hydroxide, dimethyldipropylammonium hydroxide, benzyltrimethylammonium hydroxide, choline hydroxide, tris(2-hydroxyethyl)methylammonium hydroxide, bis(2-hydroxyethyl)-dimethylammonium hydroxide, bis(2-hydroxyethyl)-diethylammonium hydroxide, tetrakis(2-hydroxyethyl)ammonium hydroxide, ammonium hydroxide, monoethanolamine, diethanolamine, triethanolamine, dimethylethanolamine, 2-amino-2-methyl-1-propanol, 2-amino-2-methyl-1,3-propanediol, 2-amino-2-ethyl-1,3-propanediol, and any combinations thereof.

5. The composition of claim 1, wherein the at least one pH adjuster is in an amount of from about 0.01% to about 20% by weight of the composition.

6. The composition of claim 1, wherein the at least chelating agent is selected from the group consisting of nitric acid, ethylenediamine, N,N,N′,N″,N″-pentamethyldiethylenetriamine, ethylenediaminetetraacetic acid, diethylenetriaminepentaacetic acid, hydroxyethylidene diphosphonic acid, aminotris(methylenephosphonic) acid, ethylenediamine tetra(methylene phosphonic acid), 1,2-diaminocyclohexanetetraacetic acid monohydrate, diethylenetriamine, triethylenetetramine, tetraethylenepentamine, aminoethylethanolamine, and salts and mixtures thereof.

7. The composition of claim 1, wherein the at least one chelating agent is in an amount of from about 0.005% to about 5% by weight of the composition.

8. The composition of claim 1, wherein the at least one corrosion inhibitor comprises an azole, a purine, or a pyrimidine.

9. The composition of claim 10, wherein the at least one corrosion inhibitor is selected from the group consisting of tetrazole, benzotriazole, tolyltriazole, 1-methyl benzotriazole, 4-methyl benzotriazole, 5-methyl benzotriazole, 1-ethyl benzotriazole, 1-propyl benzotriazole, 1-butyl benzotriazole, 5-butyl benzotriazole, 1-pentyl benzotriazole, 1-hexyl benzotriazole, 5-hexyl benzotriazole, 5,6-dimethyl benzotriazole, 5-chloro benzotriazole, 5,6-dichloro benzotriazole, 1-(chloromethyl)-1H-benzotriazole, chloroethyl benzotriazole, phenyl benzotriazole, benzyl benzotriazole, aminotriazole, aminobenzimidazole, pyrazole, imidazole, aminotetrazole, adenine, xanthine, cytosine, thymine, uracil, 9H-purine, guanine, isoguanine, hypoxanthine, benzimidazole, thiabendazole, 1,2,3-triazole, 1,2,4-triazole, 1-hydroxybenzotriazole, 2-methylbenzothiazole, 2-aminobenzimidazole, 2-amino-5-ethyl-1,3,4-thiadiazole, 3,5-diamino-1,2,4-triazole, 3-amino-5-methylpyrazole, 4-amino-4H-1,2,4-triazole, and combinations thereof.

10. The composition of claim 1, wherein the at least one corrosion inhibitor is in an amount of from about 0.001% to about 5% by weight of the composition.

11. The composition of claim 1, further comprising at least one low-k removal rate inhibitor.

12. The composition of claim 11, wherein the at least one low-k removal rate inhibitor is a non-ionic surfactant.

13. The composition of claim 11, wherein the at least one low-k removal rate inhibitor is selected from the group consisting of alcohol alkoxylates, alkylphenol alkoxylates, tristyrylphenol alkoxylates, sorbitan ester alkoxylates, polyalkoxylates, polyalkylene oxide block copolymers, tetrahydroxy oligomers, alkoxylated diamines, and mixtures thereof.

14. The composition of claim 11, wherein the at least one low-k removal rate inhibitor is in an amount of from about 0.001% to about 5% by weight of the composition.

15. The composition of claim 1, wherein the particle dispersion agent is a water-soluble polymer.

16. The composition of claim 15, wherein the water-soluble polymer is a non-ionic polymer selected from the group consisting of polyoxyethylene sorbitan monolaurate, polyoxyethylene sorbitan monopalminate, polyoxyethylene sorbitan monostearate, polyoxyethylene sorbitan monooleate, and mixtures thereof.

17. The composition of claim 15, wherein the water soluble polymer is an anionic polymer formed from one or more monomers selected from the group consisting of (meth)acrylic acid, maleic acid, acrylic acid, acrylamide, malic acid, methacrylic acid, vinyl phosphonic acid, vinyl phosphoric acid, vinyl sulfonic acid, allyl sulfonic acid, styrene sulfonic acid, acrylamidopropyl sulfonic acid, phosphonic acid, phosphoric acid, butadiene/maleic acid, caprolactam, etherimide, 2-ethyl-2-oxazoline, N-iso-propylacrylamide, sodium phosphinite, and co-formed products thereof, and sodium, potassium, and ammonium salts thereof.

18. The composition of claim 15, wherein the water soluble polymer is selected from the group consisting of poly(4-styrenylsulfonic) acid (PSSA), polyacrylic acid (PAA), poly(vinylphosphonic acid)(PVPA), poly(2-acrylamido-2-methyl-1-propanesulfonic acid), poly(N-vinylacetamide)(PNVA), polyethylenimine (PEI), anionic poly(methyl methacrylate) (PMMA), anionic polyacrylamide (PAM), polyaspartic acid (PASA), anionic poly(ethylene succinate)(PES), anionic polybutylene succinate (PBS), poly(vinyl alcohol)(PVA), 2-propenoic acid copolymer with 2-methyl-2-((1-oxo-2-propenyl)amino)-1-propanesulfonic acid monosodium salt and sodium phosphinite, 2-propenoic acid copolymer with 2-methyl-2-((1-oxo-2-propenyl)amino)-1-propanesulfonic acid monosodium salt and sodium hydrogen sulfite sodium salt, 2-acrylamido-2-methyl-1-propanesulfonic acid-acrylic acid copolymer, poly(4-styrenesulfonic acid-co-acrylic acid-co-vinylphosphonic acid) terpolymer, and mixtures thereof.

19. The composition of claim 15, wherein the water-soluble polymer is in an amount of from about 0.01% to about 5% by weight of the composition

20. The composition of claim 1, wherein the pH is from 8 to 13.

21. The composition of claim 1, wherein the composition has at most about 0.2% by weight of abrasive particles.

22. The composition of claim 1, wherein the composition is substantially free of abrasive particles.

23. A method, comprising:
applying the composition of claim 1 to a polished substrate comprising ruthenium or an alloy thereof on a surface of the substrate in a polishing tool; and
bringing a pad into contact with the surface of the substrate and moving the pad in relation to the substrate to form a rinse polished substrate.

24. The method of claim 23, further comprising removing the rinse polished substrate from the polishing tool and performing a post-CMP cleaning in a cleaning tool on the rinse polished substrate.

25. The method of claim 24, wherein the post-CMP cleaning is performed by contacting the rinse polished substrate with a composition of claim 1.

26. The method of claim 23, further comprising forming a semiconductor device from the substrate.
